(19) United States
(12) Patent Application Publication
(10) Pub. No.: US 2006/0249959 A1
(43) Pub. Date: Nov. 9, 2006

(54) Lock with symmetrical nut

(76) Inventor: Peter Riznik, Tillmitsch (AT)

Correspondence Address: KOHLER SCHMID MOEBUS, RUPPMANNSTRASSE 27, D-70565 STUTTGART, DE

(21) Appl. No.: 11/192,206

(22) Filed: Jul. 29, 2005

(30) Foreign Application Priority Data
May 9, 2005 (DE) 20 2005 007 314.8

(51) Int. Cl. E05C 1/12

(52) U.S. Cl. 292/169.16

(57) ABSTRACT

A lock (1) has at least one latch (4) which can be operated directly or indirectly via a nut (3). The nut (3) itself can be operated via an operating element. It can be rotated out of a base position both in a clockwise direction and counterclockwise direction, and cooperates with the latch (4) in such a manner that the latch (4) is moved in the same direction irrespective of its direction of rotation.

The invention concerns a lock with at least one latch which can be operated either directly or indirectly via a nut, wherein the nut can be operated via an operating element.

Locks are conventionally used for doors, wherein the locks comprise at least one latch which holds the door in a closed position. The locks are designed in such a manner that, upon operation of an operating element, the latch of the lock is retracted to permit opening of the door. Towards this end, a nut of the lock is directly or indirectly connected to an operating element and the rotary motion of the nut is converted into a linear motion of the latch. Problems arise with the use of fittings comprising the operating element, which can be rotated only in one direction. Further problems can result if a lock of this type is used both for right and left-handed doors. Additional transmissions are often required to ensure that the nut is driven in the correct direction for retraction of the latch.

It is the object of the present invention to further develop a lock in such a manner that it can be universally used.

This object is achieved by a lock of the above-mentioned type, wherein the nut is disposed to be rotatable both in clockwise and counterclockwise directions from a base position, and cooperates with the latch in such a manner that motion of the latch in the same direction is effected irrespective of the direction of rotation of the nut. Due to this measure, it does not matter whether an operating element is operated in a clockwise or counterclockwise direction. Retraction of the latch is ensured in any case. A lock of this type is therefore suited for any type of operating element to be installed on both left and right-handed doors.

In a preferred embodiment, the nut may comprise a control section, in particular a control surface, which is substantially symmetrical with respect to a symmetry plane, in particular, a center plane of the nut. The control section may immediately engage the latch or intermediate (gear) elements. In a base position, one location of the control section disposed in the symmetry plane may e.g. abut the respective element to be driven. If the nut is rotated out of this base position, the element to be driven is moved in the same manner irrespective of the direction of rotation.

The rotary motion of the nut is simply transformed into a linear motion of the latch in that the control section of the nut engages a latch slider as element to be driven, which itself drives a latch lever engaging the latch.

Support of the latch on a lock housing part via an elastic element, in particular a latch spring, ensures reliable retention of the door in a closed position by the latch. This means, however, that the latch must be retracted against a restoring force. After retraction of the latch, the latch is automatically returned into the base position due to the elastic element, thereby also automatically returning the nut into the base position.

In a particularly preferred embodiment of the invention, the nut comprises two parts, each having a control section, in particular, a control surface. This measure ensures that the nut retracts the latch upon any operation. A divided nut of this type permits, in particular, mounting of the lock to a door for right or left-handed applications using different fittings. This is particularly advantageous if fittings, such as e.g. a thumb latch fitting, are to be mounted which can rotate only in one direction. A divided nut is advantageous to permit mounting of fittings of this type on the inside and outside of the door. If a latch key is e.g. mounted to the inner side of the door, which can be moved only downwards, thereby predetermining the direction of rotation of the nut, a similar latch key mounted to the outer side of the door would cause an opposite direction of rotation. This would, however, be prevented by the inner fitting if only one nut is provided which is rigidly connected to both fittings.

In a particularly preferred manner, the nut parts can be driven irrespectively of each other. This means that the nut parts can be rotated relative to each other. With the divided nut, both nut parts can be rotated in different directions by different fittings, e.g. a first nut part by the operating element of a fitting on the inner side of the door, and a second nut part by the operating element of a fitting on the outer side of the door. There are four possibilities of retracting the latch, since each nut part can be rotated in a clockwise and counterclockwise direction to open or retract the latch.

If the control sections of both nut parts are symmetrical relative to a symmetry plane, in particular a central plane of the nut, both nut parts can retract the latch irrespective of their direction of rotation thereby exerting the same force.

In a preferred embodiment, the control sections of the nut parts may have control surfaces of different shapes. The control surfaces may have, in particular, different radii of curvature, thereby realizing different transmissions which permits adjustment of the force required by an operating element to retract the latch. A different force may e.g. be required for operating a thumb latch than for operation using another operating means.

The drawing schematically shows preferred embodiments of the invention which are described in more detail below with reference to the figures of the drawing.

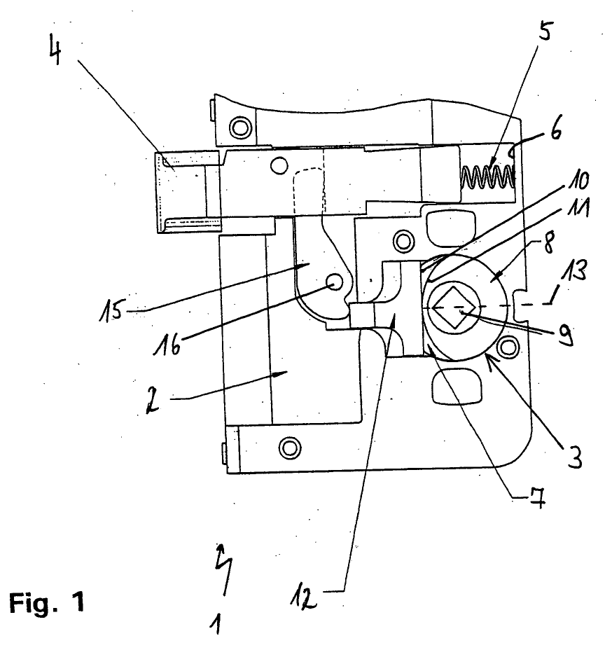

FIG. 1 shows a view of part of a lock with removed upper lock plate and a nut disposed in the base position;

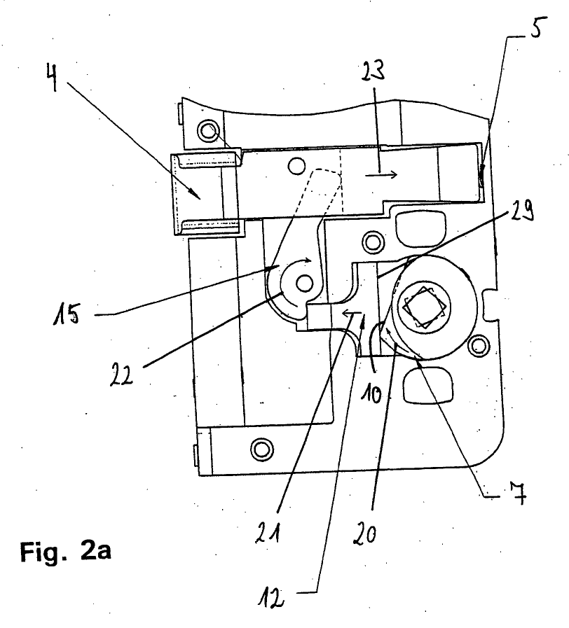

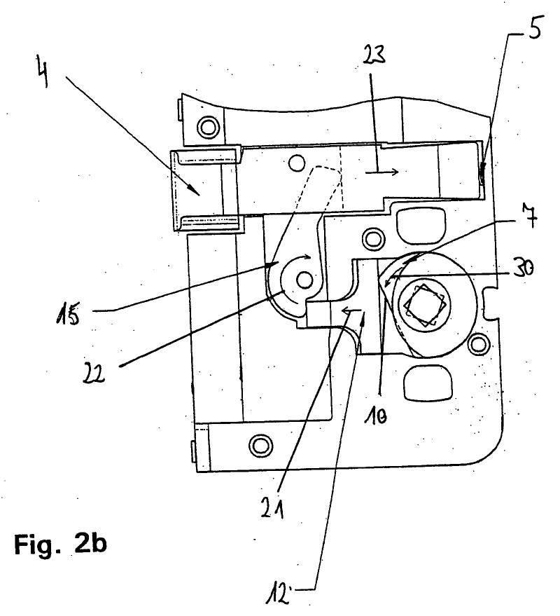

FIG. 2a shows the lock of FIG. 1 with a latch which is retracted through rotation in a clockwise direction of a first nut part;

FIG. 2b shows the lock of FIG. 1 with a latch which is retracted through rotation of the first nut part in a counterclockwise direction;

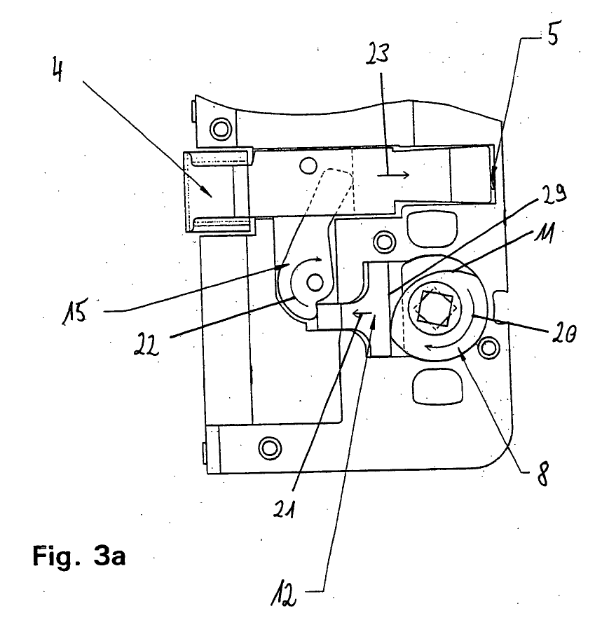

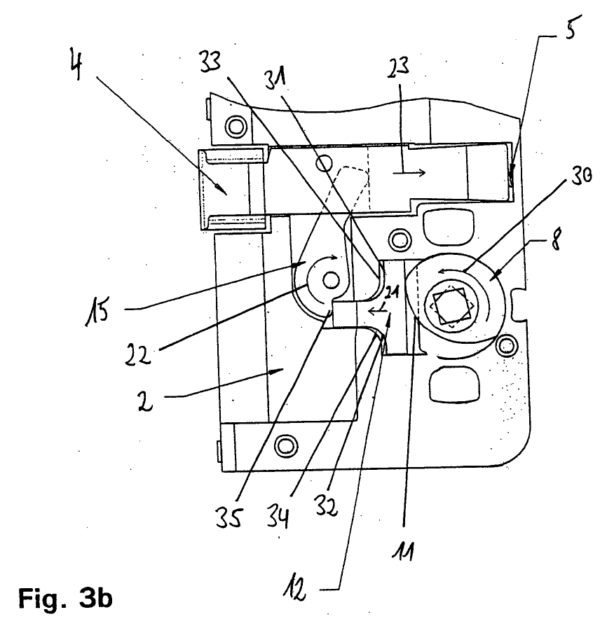

FIG. 3a shows the lock of FIG. 1 with a latch which is retracted through rotation of a second nut part in a clockwise direction;

FIG. 3b shows the lock of FIG. 1 with a latch which is retracted through rotation of the second nut part in a counterclockwise direction.

FIG. 1 shows a section of a lock 1, wherein a lower lock plate 2 accommodates the different lock parts. An upper lock plate and the lower lock plate 2 together form a lock housing. A latch 4 is retracted against a restoring force through operation of a nut 3 to release the lock of a door or the like, into which the lock 1 is mounted, to be opened. The restoring force is exerted by an elastic element 5 designed as spring, which is supported on one side on the latch 4 and on the other side on a lock housing part 6.

The nut 3 consists of two parts, wherein a first nut part 7 is disposed below a second nut part 8. The nut parts 7, 8 can also be regarded as independent nuts. Both nut parts 7, 8 have a square socket 9 to produce an effective connection with an operating element, wherein each nut part 7, 8 may be associated with its own operating element. The nut 3 or the nut parts 7, 8 are shown in the base position. The nut parts 7, 8 each have a control section 10, 11 designed as a control surface for engaging a latch slider 12. The control sections 10, 11 as well as the nut parts 7, 8 in the embodiment shown are symmetrical with respect to a symmetry plane 13, in the present case, a central plane. In the base position shown, the control sections 10, 11 at least partially abut the latch slider 12. The latch slider 12 itself cooperates with a latch lever 15 which is pivotably disposed about a pivot axis 16. The latch lever 15 engages the latch 4.

The first nut 7 of FIG. 2a is operated by an operating element (not shown) and thereby turned in a clockwise direction 20. Due to this rotation, the control section 10 displaces the latch slider 12 in the direction of arrow 21 by sliding with its lower end on the surface 29 of the latch slider 12, which again rotates the latch lever 15 in the direction of arrow 22, thereby retracting the latch 4 in the direction of arrow 23 and compressing the elastic element 5.

In FIG. 2b, the first nut 7 is operated by an operating element (not shown) and turned in the counterclockwise direction 30. Due to this rotation, the control section 10 displaces the latch slider 12 in the direction of arrow 21, which causes rotation of the latch lever 15 in the direction of arrow 22, thereby retracting the latch 4 in the direction of arrow 23 and compressing the elastic element 5. This means that, irrespective of the direction of rotation of the first nut part 7, the latch 4 has been retracted. The second nut part 8 thereby remains in the base position.

In FIG. 3a, the second nut 8 is operated by an operating element (not shown) and thereby rotated in the clockwise direction 20. Due to this rotation, the control section 11 slides along the surface 29 of the latch slider 12 displacing it in the direction of arrow 21 which causes rotation of the latch lever 15 in the direction of arrow 22 thereby retracting the latch 4 in the direction of arrow 23 and compressing the elastic element 5.

In FIG. 3b, the second nut 8 is operated by an operating element (not shown) and thereby rotated in the counterclockwise direction 30. Due to this rotation, the control section 11 displaces the latch slider 12 in the direction of arrow 21, which again causes rotation of the latch lever 15 in the direction of arrow 22, thereby retracting the latch 4 in the direction of arrow 23 and compressing the elastic element 5. This means, that the latch 4 was retracted irrespective of the direction of rotation of the second nut part 8. The first nut part 7 thereby remains in the base position.

The control sections 10, 11 of the nut parts 7, 8 have different designs. In particular, the control section 11 is curved, whereas the control section 10 is straight. The control section 11 therefore has a smaller radius of curvature. For this reason, with the use of the second nut part 8, the operating force required to deflect the latch slider 12 in the direction of arrow 21 is reduced.

The latch slider 12 is T-shaped and defines stops 31, 32 which can abut stops 33, 34 of the lower lock plate 2, thereby limiting the motion of the latch slider 12 in the direction of arrow 21. The latch slider 12 engages a nose 35 of the latch lever 15 to cause deflection of the latch lever 15.

1-8. (canceled)

9. A lock comprising:
a latch;
a nut cooperating directly or indirectly with said latch for operation thereof;
an operating element cooperating with said nut for rotation thereof, wherein said nut is disposed in said lock for rotation in both a clockwise and a counter-clockwise direction with respect to a base position thereof, said nut cooperating with said latch to move said latch in a same direction, irrespective of a direction of rotation of said nut.

10. The lock of claim 9, wherein said nut comprises a control section which is symmetrical with respect to a symmetry plane of said nut.

11. The lock of claim 10, wherein said control section has a control surface.

12. The lock of claim 10, wherein said symmetry plane is a control plane.

13. The lock of claim 10, wherein said control section of said nut engages a latch slider which drives a latch lever engaging said latch.

14. The lock of claim 1, wherein said latch is supported on a lock housing part via an elastic element.

15. The lock of claim 14, wherein said elastic element is a latch spring.

16. The lock of claim 9, wherein said nut comprises two parts, which each have a control section.

17. The lock of claim 16, wherein said control section has a control surface.

18. The lock of claim 16, wherein said nut parts can be driven independently of each other.

19. The lock of claim 16, wherein said control sections of both said nut parts are symmetrical relative to a symmetry plane of said nut.

20. The lock of claim 19, wherein said symmetry plane is a central plane.

21. The lock of claim 16, wherein said control sections of said nut parts have control surfaces.

22. The lock of claim 21, wherein said control surfaces have different radii of curvature.
